(19) United States
(12) Patent Application Publication
(10) Pub. No.: US 2010/0069272 A1
(43) Pub. Date: Mar. 18, 2010

(54) ENHANCED CRUDE OIL RECOVERY

(75) Inventors: Mikel Morvan, Aigremont (FR); Hélène Lannisbois Drean, Charenton Le Pont (FR); Denis Bende-Jacq, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations, Aubervilliers (FR)

(21) Appl. No.: 12/517,715

(22) PCT Filed: Dec. 22, 2007
(86) PCT No.: PCT/FR2007/002016

§ 371 Date: Jun. 4, 2009

(30) Foreign Application Priority Data
Dec. 22, 2006 (FR) 0611263

(51) Int. Cl. C09K 8/68

(52) U.S. Cl. 507/238

(57) ABSTRACT

The present invention relates to the use of phosphate esters as surfactants in techniques for enhanced crude oil recovery from underground formations. The invention also relates to formulations that can be used in enhanced crude oil recovery methods and to be contacted with the rocks of underground formations.

The present invention relates to the use of phosphate esters as surfactants in the technique for the enhanced recovery of crude oil from subterranean formations. The invention also relates to formulations which can be used for enhanced oil recovery methods intended to be brought into contact with the rocks of subterranean formations.

### PRIOR ART

In the context of the production of crude oil from subterranean formations, there exist various methods for optimizing the extraction of original oil in place (OOIP).

The method for the primary production of crude oil consists, once the well has been drilled, in recovering the crude oil by migration of the oil from the rock formation or from the sand to a well of lower pressure and of then pumping it to the surface via an “output” well. For this reason, primary production is the least expensive extraction method. Typically only 10 to 15% of OOIP is recovered. Nevertheless, as the petrol is pumped, the pressure decreases and extraction becomes more difficult.

Secondary production methods are then employed when the subterranean pressure becomes inadequate to displace the remaining oil.

The commonest technique, water flooding, uses injection wells which force large volumes of water under pressure into the zone comprising oil. During its migration from the zone towards one or more output well(s), the injected water carries along a portion of the oil which it encounters. At the surface, the oil is separated from the injected water and the water is again injected. Water flooding makes it possible to recover an additional 10 to 30% of OOIP.

When water flooding reaches the point where production is no longer profitable, a decision has to be taken: the change of field pure and simple or recourse to another phase of exploitation. It is then possible to use an enhanced recovery technique using water flooding in which the water comprises surface-active agents (surfactant flooding). These water-dispersible surfactants, on contact with oil present in the rock or the sand, lower the water/oil interfacial tension in order to make it possible to carry along the oil trapped in the constrictions of pores. This known technique of the literature, which would result in the recovery of an additional 15 to 25% of OOIP, has never been employed industrially. Although relatively more expensive than the other production techniques, this technique is going to become essential in making the maximum use of a deposit already discovered, in particular in view of the rise in the price of oil.

There thus exists a need to demonstrate surface-active agents, used for the enhanced oil recovery technique, which make it possible to increase even more the amount of OOIP extracted.

However, the lowering in the water/oil interfacial tension varies according to many parameters, such as in particular the salinity of the water, the temperature and the pH. The result of this is that the recovery of OOIP can vary greatly according to these conditions.

The surfactants most often envisaged for enhanced recovery techniques are surfactants of sulphonate type. However, these surfactants reveal their limit when they are used under extreme conditions, in particular at salinities of greater than 100 g/l.

There thus exists a need to demonstrate surface-active agents capable, under broad temperature and salinity conditions, of lowering the water/oil interfacial tension whatever the conditions, in order to best optimize the OOIP.

### INVENTION

The Applicant Company has demonstrated, entirely surprisingly, that some phosphate esters make it possible to significantly lower the water/oil interfacial tension, so as to very efficiently detach the oil from the rock or sand and to optimize the extraction of original oil in place. It appears that, highly advantageously, these surfactants operate in particular within broad salinity and temperature ranges, in particular under extreme conditions of temperature, in particular of greater than 70° C., and of salinity, in particular up to 200 g/l.

These surfactants of phosphate alkyl ester type correspond to the following formulae:

RO(C₃H₆O)ₓ—(C₂H₄O)_{y}—P(═O)(OM)₂ (I)

and/or

[RO(C₃H₆O)ₓ—(C₂H₄O)_{y}]₂—P(═O)(OM) (II)

in which:
R is a saturated or unsaturated, cyclic or aromatic, linear or branched, aliphatic hydrocarbon chain which can comprise heteroatoms, in particular P, S, N or O;
x is on average between 0 and 20,
y is on average between 1 and 20,
M is an alkali metal, such as H, Na or K, or an organic base.

It is thus possible to use a phosphate monoalkyl ester of formula (I), a phosphate dialkyl ester of formula (II) or a mixture of the compounds of formulae (I) and (II).

A main subject-matter of the invention is the use of at least one phosphate ester of formula (I) and/or (II) as surfactant in the enhanced oil recovery technique.

The present invention also consists of a method for the enhanced recovery of oil from a subterranean formation, in which a fluid comprising at least one surfactant of phosphate ester type of formula (I) and/or (II) is injected into the said formation and the said fluid is conveyed through this formation in order to displace the oil from the formation and to recover it.

The invention consists more particularly of a method for the enhanced recovery of oil from a subterranean formation comprising at least the following stages:

a) a liquid comprising at least:
i) an aqueous medium,
ii) a surfactant of phosphate ester type of formula (I) and/or (II), and
iii) optionally a cosurfactant,
   is injected via at least one injection means in contact with the subterranean formation,
   b) the said liquid, comprising oil, is recovered via at least one output means.

The invention also relates to a formulation suitable in particular for enhanced oil recovery, comprising at least one aqueous liquid, a surfactant of phosphate ester type of formula (I) and/or (II) and optionally a cosurfactant.

Within the meaning of the invention, the names crude oil or oil are used similarly.

Within the meaning of the invention, the names micro-emulsion or Winsor III are used similarly.

Within the meaning of the invention, the term enhanced oil recovery (EOR) method is understood to mean a technique for the recovery of crude oil from a subterranean formation using water flooding in which the water comprises surface-active agents (surfactant flooding).

On contact with an oil which may be present in the subterranean formation, suitably chosen surfactants are distributed between the water, the oil and a third phase, referred to as microemulsion or Winsor III, combining water, oil and surfactant at the interface. It is known that, in a system of Winsor III type, the interfacial tension between the oil and the aqueous phase is very low. The existence of a microemulsion (or Winsor III) in a water/oil/surfactant ternary mixture is thus evidence, a posteriori, that a surfactant is capable of significantly reducing the water/oil interfacial tension: this makes it possible in practice to extract the oil trapped in the porosity of the rock as the high interfacial tension is one of the limitations on the displacement of the oil and thus on its recovery.

The compounds according to the invention make it possible to obtain a ternary phase diagram exhibiting a Winsor III, under many conditions of salinity, of temperature and of pH. Microemulsions having a water/oil interfacial tension of less than or equal to 10⁻² mN/m at 25° C. are generally obtained.

The use of microemulsions and the significant reduction in the water/oil interfacial tension for enhanced oil recovery is well known. Mention may be made, to this end, of: Bourrel M, 1988, “Microemulsions and related systems: formulation, solvency and physical-chemistry properties”, Surfactant Science Series, Marcel Dekker; Chapotin D et al., 1986, “The Chateaurenard (France) industrial microemulsion pilot design and performance”, SPE, 14, 955; Levitt D. B et al., 2006, “Identification and evaluation of high performance EOR surfactants”, SPE, 100089.

Use may thus be made of a phosphate monoalkyl ester of formula (I), a phosphate dialkyl ester of formula (II) or a mixture of the compounds of formulae (I) and (II). The proportion by weight in the final reaction mixture of the phosphate monoalkyl ester of formula (I) to the phosphate dialkyl ester of formula (II) is generally controlled by the method of synthesis of the phosphate alkyl esters.

The phosphate esters of the invention can in particular be synthesized by reacting an alcohol of formula R—OH with phosphorus pentoxide. In order to obtain compositions enriched in phosphate monoalkyl ester, it is possible to dissolve a solution of phosphoric acid in an organic alcohol while remaining under nonreactive conditions, then to add phosphorus pentoxide to this mixture and subsequently to carry out the reaction at temperature. The phosphate esters of the invention can be synthesized in particular by the method mentioned in Application EP 0 675 076.

Preferably, use is made of a ratio by weight of phosphate monoalkyl ester of formula (I) with respect to the phosphate dialkyl ester of formula (II) generally between 80/20 and 20/80. The total molar concentration of phosphorus can be obtained by acid/base titration of the phosphate functional groups. The monoalkyl/dialkyl (molar) ratio can be measured by ³¹P nuclear magnetic resonance.

It is also possible to use several phosphate monoalkyl esters of formula (I) or several phosphate dialkyl esters of formula (II) or a mixture of these compounds of formulae (I) and (II).

The hydrocarbon chain R can be of the alkyl, alkenyl, cycloalkyl, aryl, alkylaryl or arylalkyl type. The hydrocarbon chain R can comprise from 1 to 30 carbon atoms and can optionally comprise heteroatoms, in particular P, S, N or O, and/or substituted groups. The hydrocarbon chain R is preferably an aliphatic hydro-carbon chain comprising from 6 to 30 carbon atoms, preferably between 8 and 18 carbon atoms. Mention may be made, by way of example, of a linear chain comprising 9 or 10 carbon atoms, which chain is recorded as C₉ or C₁₀, or a branched chain comprising 13 carbon atoms such as isotridecyl.

The values x and y correspond to the mean number of propoxy or ethoxy groups respectively of the compounds according to the invention. These values are said to be “mean” in the sense that it is possible to have a dispersion of these values for the said compounds. For a mean value of x or y, a compound can comprise from 1 to 2x or from 1 to 2y propoxy or ethoxy groups.

It is possible to thoroughly measure the mean value of x and y by conventional techniques known to a person skilled in the art, such as, for example, proton or carbon NMR.

x is preferably between 0 and 10 and more preferably between 0 and 4. y is preferably between 2 and 12, more preferably between 3 and 9, in particular 3, 4, 5, 6, 7 or 8, or any values within these ranges.

M can be an organic base, in particular an amine derivative, such as, for example, triethylamine, dimethylcyclohexylamine or aminomethylpropanol.

The molecular structure of the surfactants of the invention affects the ability to form a system of Winsor III type in salt water/oil mixtures. It is entirely possible, with the aim of reducing the water/oil interfacial tension, to vary the length of the hydrocarbon chain R, the monoester/diester ratio, the mean ethoxylation and propoxylation number or the neutralization of the phosphate functional group, in particular in order to cause the oil dissolution capacity to vary within a wide range of temperatures and salinities.

The phosphate alkyl esters of the invention are preferably chosen from the group consisting of the compounds of formula (I) and/or (II) mentioned in the following table:

| | R | x | y | M |
|---|---|---|---|---|
| 1 | isotridecyl | 0 | 5.7 | H |
| 2 | isotridecyl | 0 | 9.0 | H |
| 3 | isotridecyl | 0 | 3.0 | H |
| 4 | C₉ | 0 | 4.4 | H |
| 5 | C₁₀ | 0 | 5.4 | H |
| 6 | isotridecyl | 2 | 9 | H |
| 7 | C₁₆-C₁₈ | 0 | 5 | triethanolamine |
| 8 | isotridecyl | 2 | 6 | H |

When use is made of a mixture of several phosphate monoalkyl esters of formula (I) or several phosphate dialkyl esters of formula (II) or a mixture of these compounds of formulae (I) and (II), it is possible to envisage using a mixture of the compounds 1 and 3 in the preceding table.

As explained above, the methods conventionally used for the enhanced recovery of oil from a subterranean formation consist in injecting, via at least one injection means in contact with the subterranean formation, a liquid comprising at least surfactants and in recovering, via at least one output means, the said liquid comprising the oil.

Such a process is fully known in itself and is mentioned in particular in U.S. Pat. No. 3,983,940.

The method according to the invention can be used to extract crude oil from various subterranean formations, in particular from offshore platforms or straight from the ground. Mention may in particular be made of subterranean formations based on water-wet rocks.

In the context of enhanced oil recovery, a liquid comprising at least one aqueous medium, a surfactant of the invention and optionally a cosurfactant is injected into the subterranean formation.

The aqueous medium can in particular be natural or synthetic seawater, in particular with a salinity of the order of 35 g/l of mono- and divalent salts, such as NaCl, KCl, CaCl₂ and MgCl₂. The formation water present in the rock can for its part exhibit a salinity of between 35 and 200 g/l of mono- and divalent salts, such as NaCl, KCl, CaCl₂ and MgCl₂.

The formulation which is injected can comprise from 0.05 to 5% by weight of surfactants of the invention.

The formulation can obviously comprise a cosurfactant. These cosurfactants can, for example, be alcohols, such as linear or branched aliphatic alcohols, ethoxylated alcohols, sulphated ethoxylated alcohols, sulphonated ethoxylated alcohols, ethoxylated phenols and sulphated ethoxylated phenols. Mention may in particular be made of isobutanol or hexanol.

Use may also be made, in the formulation, of viscosifying polymers, such as xanthan gum, natural or modified guars, hydrolyzed polyacrylamides or 2-acrylamido-2-methylpropanesulphonic acid (AMPS) copolymers.

A specific language is used in the description so as to facilitate the understanding of the principle of the invention. Nevertheless, it should be understood that no limitation on the scope of the invention is envisaged by the use of this specific language. Modifications or improvements can in particular be envisaged by a person conversant with the technical field concerned on the basis of his own general knowledge.

The term and/or includes the meanings and, or and all the other possible combinations of the elements connected to this term.

Other details or advantages of the invention will become more clearly apparent in the light of the examples given below purely by way of indication.

### EXPERIMENTAL PART

The compounds used are as follows:
TA1 (Rhodafac RS 610): 70/30 mixture by weight of phosphate esters of formulae (I) and (II) respectively, with R=isotridecyl, x=0, y ˜5.7 and M=H,
TA2 (Rhodafac RS 710): 70/30 mixture by weight of phosphate esters of formulae (I) and (II) respectively, with R=isotridecyl, x=0, y=9.0 and M=H,
TA3 (Rhodafac RS 410): 70/30 mixture by weight of phosphate esters of formulae (I) and (II) respectively, with R=isotridecyl, x=0, y=3.0 and M=H.

The Rhodafac RS compounds are products sold by Rhodia.

### EXAMPLE 1

### Solubility Test

The surfactants of the invention are soluble in salt water and this solubility is stable at different temperatures.

The stability of the solubility of a solution comprising 1% by weight of TA1 or TA2 in a synthetic seawater comprising 24.8 g/l of NaCl, 11.8 g/l of MgCl₂, 0.8 g/l of KCl, 1.6 g/l of CaCl₂ is measured at 25° C., 50° C. or 70° C.

It is observed that the two solutions are perfectly stable at the different temperatures.

### EXAMPLE 2

### Microemulsion as a Function of the Level of Salt

A mixture of 4% by weight of sec-butanol (cosurfactant), 2% by weight of TA1 and a mixture of 50% synthetic seawater (% by volume with regard to the remaining total weight) and of 50% liquid petrolatum (% by volume with regard to the remaining total weight), for a total weight of 3 g, is prepared in a tube.

The appearance of a system of Winsor III type is observed with different levels of salts of the synthetic seawater: 35 to 50 g/l of salts at ambient temperature.

### EXAMPLE 3

### Use of Different Surfactants

Different surfactants according to the invention can be used in combination to obtain a microemulsion.

A mixture of the different compounds as mentioned in the following Table 1 (in grams, for a total of 3 g) is prepared in a tube and the appearance of a system of Winsor III type is observed.

TABLE 1

| | Seawater | Liquid | sec- | | | |
|---|---|---|---|---|---|---|
| | (39 g/l) | petrolatum | Butanol | TA1 | TA3 | State |
| Sample A | 1.462 | 1.265 | 0.172 | 0.061 | 0.03 | Winsor |
| | | | | | | III |
| Sample B | 1.467 | 1.274 | 0.173 | 0 | 0.09 | Winsor |
| | | | | | | III |

### EXAMPLE 4

### Microemulsion as a Function of the Level of Salt Using Different Surfactants

3% by weight of surfactants and 6% by weight of sec-butanol are dispersed in a total volume Vo made of a 50/50 salt water+liquid petrolatum mixture; the salinity is variable (37 g/l, 50 g/l, 75 g/l, 100 g/1,125 g/l) and the surfactant is a mixture of TA1 and TA3; the total amount of surfactants remains fixed (3%) and there are 3 TA1(TA1+TA3) ratios adopted (0.66, 0.5 and 0.33). The mixtures develop to a pH of 1.3, which is the natural acidic pH imposed by the surfactant at the end of the synthesis.

These 15 samples are subsequently analysed at ambient temperature: they are examined for the appearance of Winsor III phase and the volume Vμe of the microemulsion is measured therein, which volume is converted to percentage by volume of microemulsion Φ=Vμe/Vo×100 (Vo denotes the total volume of the formulation comprising the water, the oil and the surfactant and cosurfactant).

The percentage of Winsor III phase (value Φ) generated at a temperature of 25° C. is shown in Table 2 below:

TABLE 2

| | | Salinity (g/l) | | | | |
|---|---|---|---|---|---|---|
| | | 37 | 50 | 75 | 100 | 125 |
| TA1/(TA1 + TA3) | 0.33 | 15.1 | 12.5 | 11.6 | 11.0 | 10.4 |
| ratio | 0.5 | 11.3 | 11.3 | 9.9 | 9.7 | 8.5 |
| | 0.66 | 10.6 | 9.1 | 10.4 | 9.5 | 9.7 |

The percentage of Winsor III (value Φ) generated at a temperature of 50° C. is shown in Table 3 below:

TABLE 3

| | | Salinity (g/l) | | | | |
|---|---|---|---|---|---|---|
| | | 37 | 50 | 75 | 100 | 125 |
| TA1/(TA1 + TA3) | 0.33 | 10.4 | 8.8 | 9.6 | 8.2 | 8.7 |
| ratio | 0.5 | 7.0 | 7.4 | 6.0 | 7.7 | 6.9 |
| | 0.66 | 6.3 | 7.6 | 6.7 | 7.9 | 8.4 |

It is observed that the TA1 and TA3 mixture forms a system of Winsor III type over the entire salinity range and over the entire temperature range of between 25 and 50° C.

### EXAMPLE 5

### Microemulsion as a Function of the pH

The following experiments are carried out: 3% by weight of TA1 alone and 6% by weight of sec-butanol are dispersed in a total volume Vo made of a 50/50 salt water+liquid petrolatum mixture; the salinity is variable (37 g/l, 50 g/l, 75 g/l, 100 g/l, 125 g/l) and the pH of the solution is varied, by addition of a controlled amount of sodium hydroxide NaOH, from the natural pH of 1.3 imposed by the surfactant up to pH 10.

The 30 samples are subsequently analysed at 25° C. and at 50° C. They are examined at the two temperatures for the presence or absence of a Winsor III microemulsion and the volume Vμe thereof is measured, which volume is converted to a percentage by volume of microemulsion as above.

The percentage of Winsor III phase (value Φ) generated at a temperature of 25° C. is shown in Table 4 below:

TABLE 4

| | | Salinity (g/l) | | | | |
|---|---|---|---|---|---|---|
| | | 25 | 50 | 75 | 100 | 125 |
| pH | 1.3 | 1.3 | 12.5 | 13.4 | 12.4 | 10.6 |
| | 2 | 0.4 | 0.2 | 12.7 | 12.4 | 10.7 |
| | 3 | 1.5 | 0.9 | 20.6 | 17.7 | 15.1 |
| | 7 | 4.1 | 0.3 | 2.3 | 12.5 | 11.9 |
| | 8 | 0.3 | 0.5 | 2.6 | 13.4 | 14.2 |
| | 9 | 2.8 | 3.0 | 4.5 | 15.0 | 13.3 |

The volumes of microemulsions generated make it possible to estimate the water/oil interfacial tension at 10⁻² mN/m at 25° C.

The percentage of Winsor III phase (value Φ) generated at a temperature of 50° C. is shown in Table 5 below:

TABLE 5

| | | Salinity (g/l) | | | | |
|---|---|---|---|---|---|---|
| | | 25 | 50 | 75 | 100 | 125 |
| pH | 2 | 12.2 | 10.5 | 9.6 | 9.4 | 8.4 |
| | 2.5 | 13.7 | 13.4 | 11.7 | 10.9 | 10.1 |
| | 3 | 14.7 | 13.9 | 12.0 | 9.9 | 10.6 |
| | 8 | 10.9 | 11.6 | 10.6 | 10.9 | 9.5 |
| | 9 | 12.4 | 11.0 | 9.9 | 9.9 | 9.8 |
| | 10 | 12.5 | 12.9 | 12.7 | 11.6 | 11.9 |

The volumes of microemulsions generated make it possible to estimate the water/oil interfacial tension at 10⁻² mN/m at 50° C.

It is observed that, when the temperature is increased, a microemulsion is obtained over a broad pH and salt range. Access is gained in particular to microemulsions within a pH range close to neutrality, which prevents it being necessary to formulate under acidic conditions which pose corrosion problems.

1-18. (canceled)

19. A method of recovering oil from a subterranean formation comprising the step of contacting said subterranean formation with at least one surfactant comprising at least one phosphate ester of the following formulae (I) and/or (II):
RO(C₃H₆O)ₓ—(C₂H₄O)_{y}—P(═O)(OM)₂ (I)
[RO(C₃H₆O)ₓ—(C₂H₄O)_{y}]₂—P(═O)(OM) (II)
wherein:
R is a saturated or unsaturated, cyclic or aromatic, linear or branched, aliphatic hydrocarbon chain that optionally comprises heteroatoms,
x ranges on average from 0 to 20,
y ranges on average from 1 to 20, and
M is an alkali metal or an organic base.

20. The method of claim 19, wherein M is H, Na, or K.

21. The method of claim 19, wherein said surfactant comprises a mixture of the compounds of formulae (I) and (II).

22. The method of claim 21 wherein the ratio by weight of the phosphate monoalkyl ester of formula (I) to the phosphate dialkyl ester of formula (II) ranges from 80/20 to 20/80.

23. The method of claim 19, wherein said surfactant comprises more than one phosphate monoalkyl ester of formula (I), more than one phosphate dialkyl ester of formula (II), or a mixture of more than one phosphate monoalkyl ester of formula (I) and more than one phosphate dialkyl ester of formula (II).

24. The method of claim 19, wherein said hydrocarbon chain R comprises an alkyl, alkenyl, cycloalkyl, aryl, alkylaryl, or arylalkyl group.

25. The method of claim 19, wherein x ranges from 0 to 10.

26. The method of claim 25, wherein x ranges from 0 to 4.

27. The method of claim 19, wherein y ranges from 2 to 12.

28. The method of claim 27, wherein y ranges from 3 to 9.

29. The method of claim 19, wherein the phosphate ester comprises at least one compound of formula (I) and/or (II), wherein:
R is isotridecyl, x is 0, y is 5.7, and M is H;
R is isotridecyl, x is 0, y is 9.0, and M is H;
R is isotridecyl, x is 0, y is 10, and M is H;
R is C₉, x is 0, y is 4.4, and M is H;
R is C₁₀, x is 0, y is 5.4, and M is H;
R is isotridecyl, x is 2, y is 9, and M is H;
R is C₁₆-C₁₈, x is 0, y is 5, and M is triethanolamine,
R is isotridecyl, x is 2, y is 6, and M is H, or
mixtures thereof.

30. A method for the recovery of oil from a subterranean formation, comprising the steps of:
a) contacting said formation with a liquid comprising at least:
i) an aqueous medium,
ii) a phosphate ester surfactant of formula (I) and/or (II):
RO(C₃H₆O)ₓ—(C₂H₄O)_{y}—P(═O)(OM)₂ (I)
[RO(C₃H₆O)ₓ—(C₂H₄O)_{y}]₂—P(═O)(OM) (II)
wherein:
R is a saturated or unsaturated, cyclic or aromatic, linear or branched, aliphatic hydrocarbon chain that optionally comprises heteroatoms,
x ranges on average from 0 to 20,
y ranges on average from 1 to 20, and
M is an alkali metal or an organic base; and
iii) optionally a co-surfactant; and
b) recovering said liquid comprising said oil from said formation.

31. A formulation for oil recovery, comprising at least one aqueous liquid, at least one phosphate ester surfactant of formula (I) and/or (II):
RO(C₃H₆O)ₓ—(C₂H₄O)_{y}—P(═O)(OM)₂ (I)
[RO(C₃H₆O)ₓ—(C₂H₄O)_{y}]₂—P(═O)(OM) (II)
wherein:
R is a saturated or unsaturated, cyclic or aromatic, linear or branched, aliphatic hydrocarbon chain that optionally comprises heteroatoms,
x ranges on average from 0 to 20,
y ranges on average from 1 to 20, and
M is an alkali metal or an organic base; and
optionally a co-surfactant.

32. The formulation of claim 31, wherein the aqueous medium is natural seawater.

33. The formulation of claim 31, wherein said phosphate ester surfactants are present in an amount ranging from 0.05 to 5% by weight.

34. The formulation of claim 31, wherein said formulation comprises a co-surfactant comprising an alcohol.

35. The formulation of claim 34, wherein the co-surfactant comprises linear or branched aliphatic alcohols, ethoxylated alcohols, sulfated ethoxylated alcohols, sulfonated ethoxylated alcohols, ethoxylated phenols, sulfated ethoxylated phenols, or mixtures thereof.

36. The formulation of claim 31, wherein said formulation further comprises a viscosifying polymer.
